(19) United States
(12) Patent Application Publication
(10) Pub. No.: US 2022/0203304 A1
(43) Pub. Date: Jun. 30, 2022

(54) CIRCULATING WATER PREPARATION SYSTEM, COOLING SYSTEM AND METHOD FOR OPERATING A COOLING SYSTEM

(71) Applicants: WATERplus GmbH, Rosenheim (DE); SFC Umwelttechnik GmbH, Sulzburg (AT)

(72) Inventors: Robert FÄRBER, Rosenheim (DE); Konrad Falko WUTSCHER, Anif (AT); Simon JABORNIG, Salzburg (AT); Franz URSTÖGER, Zell am Moos (AT); Roland MAYER, Salzburg (AT)

(21) Appl. No.: 17/601,376

(22) PCT Filed: Apr. 2, 2020
(86) PCT No.: PCT/EP2020/059405

§ 371 Date: Oct. 4, 2021

(30) Foreign Application Priority Data
Apr. 2, 2019 (DE) 20 2019 001 503.5

(51) Int. Cl. B01D 65/02; B01D 61/14; C02F 1/44; C02F 1/50; F28D 5/02

(52) U.S. Cl. CPC B01D 65/02; B01D 61/145; B01D 61/147; C02F 1/444; C02F 2103/023; F28D 5/02; B01D 2311/25; B01D 2321/04; B01D 2321/18; C02F 1/50

(57) ABSTRACT

A circulating water preparation system for cooling plants, a cooling system, in particular a recooling system, and a method for operating such a cooling system. In such a cooling system a surface of a heat exchanger is cooled by wetting with water, the water is collected in a collecting tank and returned by means of a water circuit for the renewed wetting of the surface of the heat exchanger. The method is characterised in that the water is purified by means of a filter, in particular a membrane filter. As a result considerably less biocide is needed to keep the water free of germs, in particular legionella, compared to conventional cooling systems or methods for operating such cooling systems.

### FIELD OF THE INVENTION

The present invention relates to a circulating water preparation system, a cooling system and a method for operating a cooling system, in particular for operating a recooling system.

### BACKGROUND OF THE INVENTION

Recooling systems are used for cooling a tempering medium cooled by way of a heat exchanger by directing an air flow to which water is added onto a surface of the heat exchanger. The surface of the heat exchanger is wetted by the water, so that heat is extracted from the surface by the water. A part of the water evaporates and results in a further cooling effect. The other part of the water is collected and circulated in a circuit.

Recooling systems have been known for a long time (e.g. DE 2 322 037 A).

Further recooling systems emerge from DE 103 16 045 A1 or DE 100 19 528 B4, for example.

It is an underlying problem of recooling systems that the water added to the air flow is heated at the heat exchanger and is in intensive contact with the air, so that germs can collect and multiply therein. By the evaporation of the water, other particles, such as pollen or soot, are concentrated in the water remaining in the circuit. In order to kill germs, in particular bacteria, in the water, a biocide is regularly added to the water in the circuit. The addition of biocide leads to a salination of the water. The water therefore has to be replaced regularly.

There has once been an accident in which aerosols infested with legionella escaped and many people in the surrounding area fell ill. Ever since, great care has been taken to ensure that enough biocide is added regularly.

Membrane filters, for example in the form of hollow fibres, have been known for a long time (e.g. EP 0 554 567 A1 or DE 31 49 423 A1).

Further membrane filters emerge from DE 102 20 916 A1 or DE 10 2016 108 202 A1, for example.

DE 10 2009 040 110 A1 describes a condensate purification system of a power station, in which filter elements made of ceramic membranes are used for cleaning the condenser.

Membranes can be used for other applications as well, however, for example for introducing oxygen into water (see e.g. DE 199 50 457 A1).

The present invention is based on the problem of creating a circulating water preparation system for cooling plants, a cooling system having such a circulating water preparation system and a method for operating such a cooling system, whereby the water in the circuit can be conducted using substantially less biocide and substantially longer retention times compared to conventional cooling plants. In this way an excessive germ load, in particular legionella load, in the water can be prevented even with small quantities of biocide.

### SUMMARY OF THE INVENTION

The circulating water preparation system according to the invention comprises a circulating water reservoir and a filter device, which are placed in a circuit, and a filtration pump for circulating recooling water in the circuit.

The recooling water is thus filtered to reduce the concentration of germs and other particles.

The inventors of the present invention have found that, by filtering the water, the need for biocides can be reduced at least to a tenth of the usual need. In conventional recooling systems approximately 5 l of biocide per day are added to the water. In Germany alone there are more than 100 000 recooling systems. If all of these recooling systems were to be fitted with a circulating water preparation system according to the invention, more than 100 000 t of biocide could be saved every year.

The germs are not killed by the filter device of the circulating water preparation system. The inventors have realised, however, that the majority of germs can be filtered out reliably and the filter device can be cleaned at regular intervals as explained in greater detail below, so that a liquid concentrated with germs and particles can be disposed of in an environmentally appropriate manner.

A membrane filter as described in DE 102 20 916 A1, for example is particularly suitable as a filter device. Such membrane filters can have a large surface area at a small filter volume.

The filter device preferably has a filter with a maximum pore size of 1 μm, in particular of 0.5 μm and particularly preferably of 0.1 μm. The maximum pore size may also be 0.05 μm or 0.02 μm or even 0.01 μm. Germs and other particles are reliably filtered out of the water with pores as small as that.

A flushing device can also be provided whereby water and/or air can be flushed in the flow direction of the filter device or against the flow direction of the filter device. This is used for cleaning the filter device. The flushing can be carried out in the flow direction or against the flow direction. A flushing against the flow direction, a so-called backflushing, with a water/air mixture is very efficient. In addition a cleaning chemical can be added with or independently of the flushing process. The cleaning chemical can be a biocide or an oxidant, an acid or an alkali.

According to a further aspect of the invention, a cooling system, in particular a recooling system, is provided, which has a heat exchanger the surface of which is cooled by an air flow to which water is added. A collecting tank for collecting the water and a water circuit for returning the water into the air flow are provided. This cooling system is characterised by the fact that the water circuit is connected to a circulating water preparation system as explained above.

With the circulating water preparation system the water is filtered and purified of germs and particles.

According to a further aspect of the invention, a method for operating a cooling system, in particular a recooling system, is provided, in which a surface of a heat exchanger is cooled by wetting with water and the water is collected in a collecting tank and returned by means of a water circuit for wetting the surface of the heat exchanger again. The method is characterised by the fact that the water is purified by means of a filter. As a result of this the use of biocides can be reduced considerably compared to conventional recooling systems.

A recooling system as explained above is preferably used in the method.

The water can be purified with a membrane filter.

The filter device can be flushed periodically with water or air or a water/air mixture. The flushing can be carried out against or in the flow direction during the filter operation. A so-called backflushing is preferred, i.e. with the flow direction being against the direction during the filter operation. This is particularly effective with a water/air mixture in membrane filters.

A cleaning chemical can be added in the flushing process.

The water can be stored temporarily in a circulating reservoir and circulated for the purification of the water in a purification circuit in which the filter device is located. In addition to the water circuit of the recooling system, a second circuit—the purification circuit—is thus provided, in which the water can be circulated independently of the operation of the recooling system.

As a biocide chlorine dioxide with an active agent concentration of 3000 ppm or sodium hypochlorite with an active agent concentration of 1600 ppm can be added in a quantity of no more than 0.3 mg/l water an hour, in particular no more than 0.2 mg/l water an hour or no more than 0.1 mg/l water an hour.

### BRIEF DESCRIPTION OF THE DRAWINGS

The invention is explained in greater detail below by way of example with reference to the drawings. The drawings show diagrammatically:

FIG. 1 is a purification circuit in a block diagram, and

FIG. 2 is a heat exchanger of a recooling system with a water circuit in a block diagram.

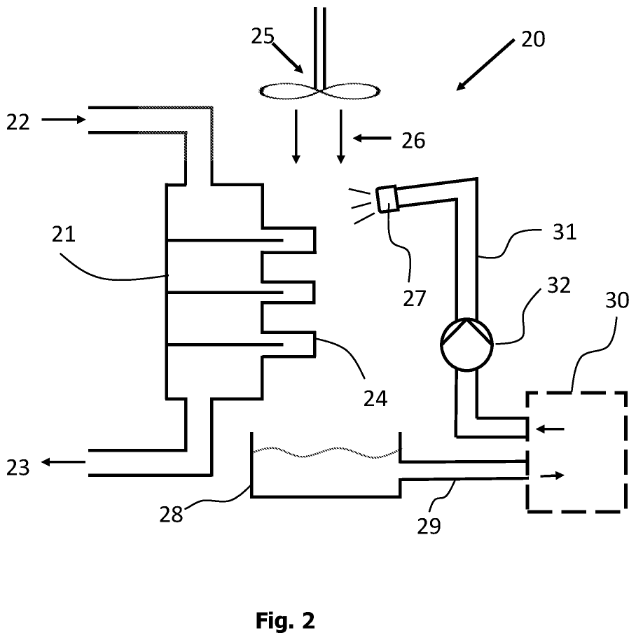

### DETAILED DESCRIPTION OF THE PREFERRED EMBODIMENTS

The recooling system 20 according to the invention has a heat exchanger 21 with an inlet 22 for feeding in a tempering medium and an outlet 23 for discharging the tempering medium. The heat exchanger 21 is provided with several fins 24, through which the tempering medium flows.

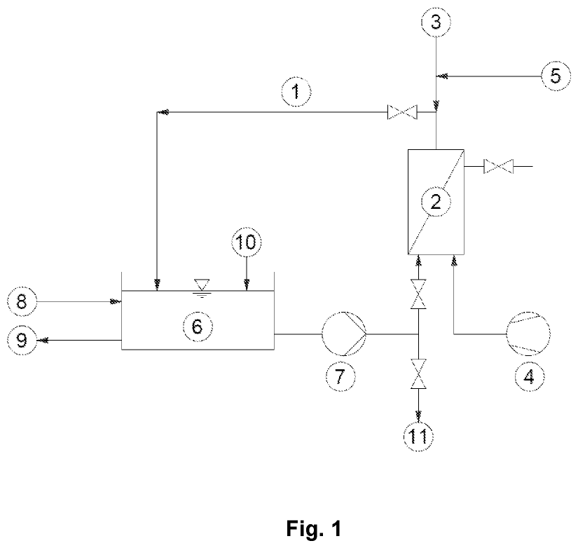

A fan device 25 generates an air flow 26 directed onto the fins 24 for the cooling thereof. With a nozzle 27 cooling water wetting the fins 24 is injected into the air flow 26. The fins 24 are cooled by the water. A part of the water evaporates, thereby generating an additional cooling effect. The remaining water drips off and is collected in a collecting tank 28. From the collecting tank 28 the water is carried by means of a line 29 to a circulating water preparation system 30, which is shown more precisely in FIG. 1 and described in greater detail below In the circulating water preparation system 30 the water is purified and then delivered via the line 31 to the nozzle 27 by means of a pump 32 and again added to the air flow 26. In this way the water is circulated in a purification circuit.

As explained above, the water collected in the collecting tank 28 is contaminated by germs or other particles because of the intensive air contact. This contaminated water 8 is fed to a circulating water reservoir 6 and there stored temporarily. The water in the circulating water reservoir 6 can be purified as explained below and again fed to the purification circuit in the form of purified cooling water 9.

With a filtration pump 7, water can be drawn from the circulating water reservoir 6 and delivered to a filter device 2. The filter device 2 is designed as a membrane filter. One or more filter cartridges with a hollow fibre membrane arrangement as described in DE 102 20 916 A1 are preferably provided.

The purified water 1 (permeate) is returned to the circulating water reservoir 6 via a line. The water of the circulating water reservoir 6 can be circulated several times before being returned to the water circuit of the recooling system 20.

The filter device 2 is connected to a fan gas flushing unit 4, with which gas can be supplied for cleaning the filter device. In the present embodiment the fan gas flushing unit 4 is located on the inlet side of the filter device 2, so that the cleaning gas, which is air as a rule, is fed to the filter device on the same side as the water (filtrate). Within the scope of the invention it is obviously also possible to provide the fan gas flushing unit 4 at the outlet of the filter device or to provide an additional fan gas flushing unit there.

On the outlet side of the filter device 2 there is located a water backflushing unit 3, which is a connection to a fresh water line as a rule. With the fresh water the filter device can be backflushed against the flow direction during the filter operation. A chemical dosing unit 5, with which cleaning chemicals can be supplied to the fresh water for backflushing the filter device 2, can be coupled to the water backflushing unit 3.

The following experiments were carried out with such a recooling system:

Experiment 1

Sodium hypochlorite (active agent concentration in the product 1600 ppm corresponds to 1600 mg/l) was used as a biocide. Using a standardised measuring method, it was determined at regular intervals whether the mandatory limit values for legionella were adhered to. As filter devices four C-MEM cartridges each, available from SFC of Umwelttechnik GmbH, Salzburg, Austria, with an overall filter area of 24 square metres, were used. The maximum pore size was 0.02 μm.

Without filtration a dosing of at least 1 mg/l circulating water an hour was necessary. This corresponds to 0.625 l biocide per 1000 l an hour or 15 l per 1000 l circulating water a day.

With the filtration a dosing of no more than 0.1 mg/l circulating water an hour was sufficient to adhere to the limit values permanently. This is less than 10% of the quantity required without filtration or less than 1.5 l per 1000 l a day.

Experiment 2

Chlorine dioxide (active agent concentration in the product 3000 ppm corresponds to 3000 mg/l) was used as a biocide. Apart from this, the same experiment was carried out.

Without filtration a dosing of more than 1 mg/l circulating water an hour was necessary. This corresponds to 0.333 l biocide per 1000 l an hour or 8 l per 1000 l circulating water a day.

With the filtration a dosing of no more than 0.1 mg/l circulating water an hour was sufficient to adhere to the limit values permanently. This is less than 10% of the quantity required without filtration or less than 0.8 l per 1000 l a day.

By providing the circulating water reservoir 6, the operation of the water circuit of the recooling system 20 is decoupled from the filter operation of the circulating water preparation system. In both circuits water can be circulated independently of each other. These two circuits can be operated simultaneously or alternately.

During operation the water circuit is often activated initially. From a certain operating time, it has then to be assumed that the water contains a certain degree of contamination. This based on empirical values and greatly depends on the germ and particle loading of the ambient air and on ambient temperature. Verified empirical values are available for this. No later than the presence of a predetermined germ or particle loading, the circulating water preparation system 30 is activated and water is circulated across the filter device 2 and purified. This cleaning operation can be continued even if the cooling system is no longer in operation and its water circuit stands idle.

This decoupling makes it possible to keep a large quantity of cooling water substantially contamination-free in the long run even with a relatively small, compact filter device and to reduce the need for biocides considerably compared to conventional systems.

Within the scope of the invention, it is also possible to provide, instead of a circulating water reservoir 6, two water reservoirs for the contaminated water entering the circulating water preparation system and for the non-contaminated water emerging from the circulating water preparation system 30. These two reservoirs can be designed separately from each other. They are preferably connected to each other by a line, however, in which at least one control valve and in particular a feed pump are provided, so that a multiple recirculation is possible here as well and can be activated in a targeted manner.

Examples of the invention are specified below:

1^{st} example: Circulating water preparation system of hybrid recooling plants or other cooling plants, characterised in that the circulating water preparation system is designed such that there is a cyclical or permanent circulation of contaminated recooling water through the circulating water preparation system and thus a partial or complete removal of microorganisms and other particulate contaminants from the circulating water.

2^{nd} example: Circulating water preparation system according to the 1^{st} example, characterised in that the circulating water preparation system is designed such that the purification of the circulating water is performed physically by a filtration according to the principle of size exclusion for particulate substances >0.1 μm.

3^{rd} example: Circulating water preparation system according to the 1^{st} or 2^{nd} example,

characterised in that
the filtration power can be held constant optionally by a cyclical water flushing of the filter and/or optionally by a cyclical gas flushing of the filter and/or optionally by a cyclical chemical cleaning of the filter by introducing oxidative and/or optionally alkaline and/or optionally acidic cleaning chemicals by way of backflushing.

4^{th} example: Circulating water preparation system according to any of the 1^{st} to 3^{rd} examples,

characterised in that
the circulating water preparation system has a circulating water reservoir (6) and a filter device (2), which are placed in a circuit, and a filtration pump (7) for circulating recooling water in the circuit.

5^{th} example: Circulating water preparation system according to the 4^{th} example,

characterised in that
the circulating water preparation system further comprises

a water backflushing unit (3) for the filter device (2) and/or

a fan gas flushing unit (4) for the filter device (2) and/or

a chemical dosing unit (5) for a chemical cleaning of the filter device (2).

1. Circulating water preparation system for cooling plants, comprising:
a circulating water reservoir and a filter device, which are placed in a circuit, and a filtration pump for circulating recooling water in the circuit.

2. Circulating water preparation system according to claim 1, wherein the filter device has a membrane filter.

3. Circulating water preparation system according to claim 1, wherein the filter device has a filter with a maximum pore size of 1 μm.

4. Circulating water preparation system according to claim 1, further comprising a flushing device, which can flush the filter device with water and/or air in and/or against a flow direction of the water and/or air.

5. Circulating water preparation system according to claim 1, further comprising a chemical dosing device for feeding a cleaning chemical to the filter device.

6. Cooling system comprising:
a heat exchanger, wherein a surface of the heat exchanger is cooled with an air flow to which water is added,
a collecting tank for collecting the water, and
a water circuit for returning the water into the airflow, wherein the water circuit is connected to the circulating water preparation system according to claim 1.

7. Method for operating the cooling system according to claim 6, comprising:
cooling the surface of the heat exchanger by wetting the surface of the heat exchanger with water;
collecting the water in the collecting tank and returned returning the water with a water circuit for the renewed wetting of the surface of the heat exchanger; and
using a filter to purify the water.

8. Method according to claim 7, comprising purifying the water with a membrane filter.

9. Method according to claim 7, comprising flushing the filter device regularly with water or air or a water/air mixture.

10. Method according to claim 9, comprising carrying out the flushing operation against or in a flow direction of the water or air or water/air mixture during the filter operation.

11. Method according to claim 9, comprising adding a cleaning chemical during the flushing operation.

12. Method according to claim 7, comprising temporarily storing the water in the circulating reservoir and circulating the water in a purifying circuit in which the filter device is located for purifying the water.

13. Method according to claim 7, comprising adding a biocide to the water.

14. Method according to claim 13, wherein the biocide is chlorine dioxide with an active agent concentration of 3000 ppm or sodium hypochlorite with an active agent concentration of 1600 ppm, added to the water in a quantity of no more than 0.3 mg/l water an hour.

15. Method according to claim 12, wherein the water in the purifying circuit is circulated cyclically or permanently.

16. Method according to claim 12, wherein the water circuit of the cooling system and the purifying circuit are operated simultaneously or alternately.
